(19) United States
(12) Patent Application Publication
(10) Pub. No.: US 2008/0136366 A1
(43) Pub. Date: Jun. 12, 2008

(54) Charging System for Wireless Mouse and Charging Method Thereof

(76) Inventor: Tung-Chi Lee, Fongyuan City (TW)

Correspondence Address: LAW OFFICES OF LAI AND ASSOCIATES, P.C., 5800 RANCHESTER STE 200, HOUSTON, TX, 77036, US

(21) Appl. No.: 11/609,484

(22) Filed: Dec. 12, 2006

(51) Int. Cl. H02J 7/00; H01M 10/44

(52) U.S. Cl. 320/103; 320/114

(57) ABSTRACT

A charging system for a wireless mouse and charging method are disclosed. The system comprises a transceiver unit having a first charging module and a circuit, and a wireless mouse body having a second charging module and a control circuit. When the wireless mouse is in normal operation, the transceiver unit is electrically connected to a port of a computer to charge power from the port by using the first charging module and to transfer data between the computer and the wireless mouse via the circuit. Alternatively, when the operation of the wireless mouse is done, the transceiver unit is plugged or snapped in the wireless mouse body to charge the second charging module with power by discharging the charged first charging module. Furthermore, when the power of the wireless mouse is used up, the second power storage unit of the second charging module of the wireless mouse body is directly replaced with the charged first power storage unit of the first charging module of the transceiver unit.

### FIELD OF THE INVENTION

The present invention generally relates to a charging system for wireless mouse and a charging method, and more specifically, to use a transceiver unit having a charging module that is plugged or snapped in the wireless mouse to recharge the battery of the wireless mouse.

### BACKGROUND OF THE INVENTION

A wireless mouse is a popular peripheral device of a personal computer, and is especially convenient for mobile computer users to be free of tangled wires. However, there are two disadvantages of the wireless mouse. The first problem is that a detached receiver may be easily lost. Another drawback is the requirement of recharge or the replacement of battery in the wireless mouse. Some wireless mice include docks for the detached receiver to be plugged in or snapped in to prevent the detached receiver from being lost, but the spare battery or the battery charger must be prepared when the battery in the wireless mouse is run out, and this is inconvenient for traveling users.

Some techniques then were developed to improve the aforesaid problems. The first prior art uses inductive coils to transfer the energy from a mouse pad to the wireless mouse to recharge the battery. A transmitting inductive coil was integrated in the mouse pad, and the coil was wired to a power source to generate electromagnetic field. A receiving inductive coil was included in the wireless mouse and accepted the inductive charge from the pad coil. However, this approach would generate extra electromagnetic wave, and the necessary mouse pad would increase the loading of the traveling users.

Another prior art integrates a charging cord in the wireless mouse. The charging cord could be pulled out from the wireless mouse and connected to an interface port of the computer to acquire the power for the battery recharging. However, the conventional method may increase the mechanism and weight of the wireless mouse, and occupy one more interface port of the computer.

To overcome the foregoing shortcomings, the inventor of the present invention, based on years of experience in the related field from conduct extensive research and experiments, invents a charging system for a wireless mouse and a charging method.

### SUMMARY OF THE INVENTION

Briefly, it is a primary object of the present invention to provide a charging system for wireless mouse and charging method thereof to recharge the battery of the wireless mouse by using a detachable transceiver unit with a charging module.

In accordance with the primary object of the present invention, the charging system comprises a transceiver unit and a wireless mouse body The transceiver unit further includes a first charging module and a circuit, and the wireless mouse body further includes a second charging module and a control circuit. When the wireless mouse is in normal operation, the transceiver unit is electrically connected to a port of a computer to charge power from the port by using the first charging module and to transfer data between the computer and the wireless mouse via the circuit, and when the operation of the wireless mouse is done, the transceiver unit is plugged or snapped in the wireless mouse body to charge the second charging module with power by discharging the first charging module.

Another object of the present invention is to provide a method for charging a wireless mouse, and the method comprises the following steps:

(1). Providing a transceiver unit with a first charging module and a circuit;

(2). Providing a wireless mouse body with a second charging module and a control circuit;

(3). Electrically connecting a port of a computer and a transceiver unit to charge power from the port by using the first charging module and to transfer data between the computer and the wireless mouse via the circuit if the wireless mouse is in normal operation; and

(4). Plugging or snapping the transceiver unit in the wireless mouse body to charge the second charging module with power by discharging the charged first charging module if the operation of the wireless mouse is done.

The circuit disposed to the transceiver unit can be a transceiver circuit that performs the data transmission and receiving, and the first charging module further comprises a first charging circuit and an auxiliary charge unit. The auxiliary charge unit can be an auxiliary charge storage device composed of at least one battery or a capacitor for storing power, and the first charging circuit controls the auxiliary charge unit to perform the charging and discharging action. The second charging module further comprises a second charging circuit and a power storage unit. The power storage unit can be a main battery composed of at least one rechargeable battery, and the second charging circuit controls the first charging circuit to perform the charging and discharging action so as to charge the power storage unit, and the control circuit performs the receiving and transmission function between the wireless mouse body and the transceiver unit.

A third object of the present invention is to provide a charging system for a wireless mouse. The charging system comprises a transceiver unit and a wireless mouse body. The transceiver unit has a circuit and a first charging module composed of a first charging circuit and a first power storage unit, and the wireless mouse body has a second charging module composed of a second charging circuit and a second power storage unit and a control circuit. When the wireless mouse is in normal operation, the transceiver unit is electrically connected to a port of a computer to use the first charging circuit to charge the first power storage unit of the transceiver unit with power from the port and to transfer data between the computer and the wireless mouse via the circuit, and when the power of the wireless mouse is used up, the second power storage unit of the wireless mouse body is directly replaced with the charged first power storage unit of the transceiver unit to continuously operate the wireless mouse without utilizing the charging and discharging action between the first charging circuit and the second charging circuit.

To make it easier for our examiner to understand the objective of the invention, its innovative features and performance, a detailed description and technical characteristics of the present invention are described together with the drawings as follows.

### BRIEF DESCRIPTION OF THE DRAWINGS

FIG. 1 is a schematic view of a charging system for a wireless mouse of the invention;

FIG. 2 is a detail schematic diagram of a charging system for a wireless mouse according to a preferred embodiment of the present invention;

FIG. 3 shows the transceiver plugged in the wireless mouse and the main battery charged with the power of the auxiliary charge storage device through the contacts;

FIG. 4 is a flowchart of a method for charging a wireless mouse of the invention;

FIG. 5 is a schematic diagram of a charging system for a wireless mouse according to another preferred embodiment of the invention; and

FIG. 6 shows a replacement mechanism for the main and spare battery and the main battery charged with the power of the spare battery through the contacts when the transceiver is plugged in the wireless mouse.

### DETAILED DESCRIPTION OF THE PREFERRED EMBODIMENTS

Referring to the related figures for the charging system for wireless mouse and charging method according to a preferred embodiment of the present invention, wherein the same elements are described by the same reference numerals.

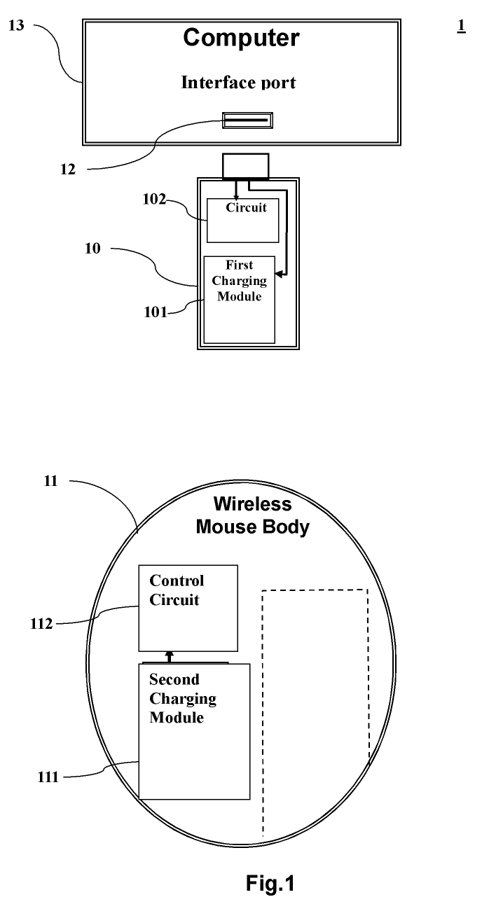

Referring to FIG. 1, a schematic diagram of a charging system for a wireless mouse of the invention, the charging system 1 comprises a transceiver unit 10 and a wireless mouse body 11, and the transceiver unit 10 has a first charging module 101 and a circuit 102, and the wireless mouse body 11 has a second charging module 111 and a control circuit 112. When the wireless mouse is in normal operation, the transceiver unit 10 is electrically connected to a port 12 of a computer 13 to charge power from the port 12 by using the first charging module 101 and to transfer data between the computer 13 and the wireless mouse via the circuit 102, and when the operation of the wireless mouse is done, the transceiver unit 10 is plugged or snapped in the wireless mouse body 11 (as shown in dotted line) to charge the second charging module 111 with power by discharging the charged first charging module 101.

The transceiver unit 10 is preferably a transceiver, and the circuit 102 is preferably a transceiver circuit that performs the data transmission and receiving, and the first charging module 101 further comprises a first charging circuit and an auxiliary charge unit. The auxiliary charge unit is preferably an auxiliary charge storage device composed of at least one battery or a capacitor for storing power. The first charging circuit controls the auxiliary charge unit to perform the charging and discharging actions. The second charging module 112 further comprises a second charging circuit and a power storage unit. The power storage unit is preferably a main battery composed of at least one rechargeable battery. The second charging circuit controls the first charging circuit to perform the charging and discharging actions so as to charge the power storage unit. The control circuit 111 can perform the receiving and transmission functions between the wireless mouse body 11 and the transceiver unit 10.

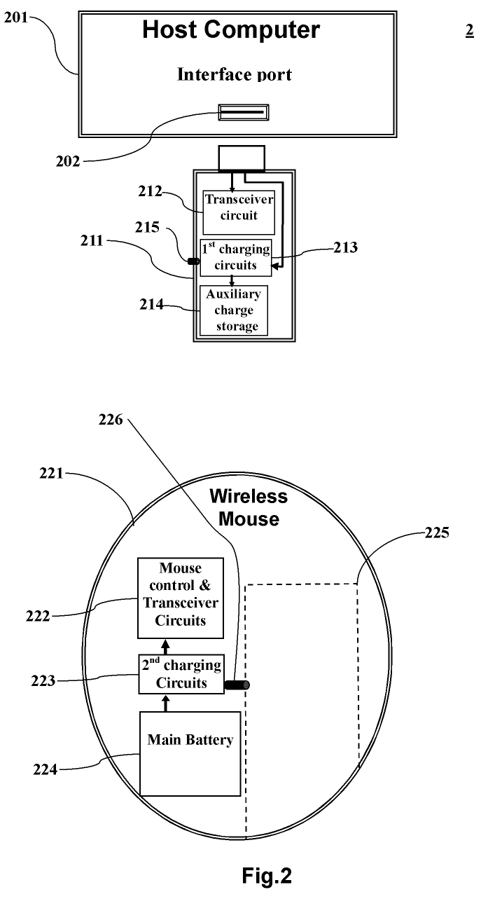

Referring to FIG. 2, a detail schematic diagram illustrates a charging system for a wireless mouse according to a preferred embodiment of the present invention. The charging system 2 comprises a wireless mouse 221 and a detachable transceiver 211. The transceiver 211 is electrically connected to an interface port 202 of a host computer 201, and transfers data between the wireless mouse 221 and the host computer 201. The transceiver includes a transceiver circuit 212, a first charging circuit 213 with contacts 215, and an auxiliary charge storage device 214. The transceiver circuit 212 receives radio signals generated from the wireless mouse 221, and then converts the radio signals into predetermined data that then is transmitted to the host computer 201. Moreover, the transceiver circuit 212 also converts data received from the host computer 201 into radio signals that then are transmitted to the wireless mouse 221. The power of the transceiver circuits 212 is supplied from the interface port 202 of the host computer 201. The auxiliary charge storage device 214 can be one or a plurality of rechargeable batteries or capacitors. The first charging circuit 213 controls the charging and discharging of the auxiliary charge storage device 214. The contacts 215 include a plurality of metal pins for signals and power interconnection between these charging circuits. The wireless mouse 221 further includes a transceiver dock 225, a control-and-transceiver circuit 222, a second charging circuit 223 with contacts 226, and a main battery 224. The transceiver dock 225 is for the storage of transceiver 211. The function of the control-and-transceiver circuit 222 converts all the user commands (mouse movement, button clicking, and scrolling-wheel rolling, etc.) into data, and transforms data into radio signals that then are transmitted to the transceiver 211. Furthermore, the control-and-transceiver circuit 222 also receives the radio signals from transceiver 211 and accesses data carried by the radio signals. The power of the control-and-transceiver circuit 222 is managed by the second charging circuit 223 and from the main battery 224. The second charging circuit 223 controls the charging and discharging operations of the main battery 224. The contacts 226 include a plurality of pins for signals and power interconnection between charging circuits. The main battery 224 can be one or a plurality of recharging batteries.

In normal mouse operation as shown in FIG. 2, the transceiver 211 is electrically connected to the interface port 202 of the host computer 201, and the user controls the wireless mouse 221 for computer operation. The transceiver-circuit 212 and the control-and-transceiver circuit 222 transfers the user commands to the host computer, and the data from the host computer 201 to the wireless mouse 221. When the first charging circuit 213 detects the power on the interface port 202, and it charges the auxiliary charge storage device 214 with the power from the interface port 202 till the auxiliary charge storage device 214 is fully charged. The second charging circuit 223 manages the discharge of main battery 224, and supplies the power to the control-and-transceiver circuit 222.

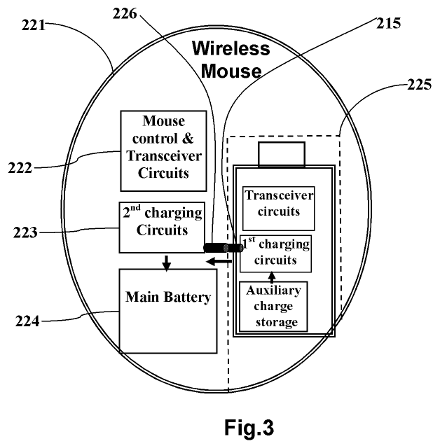

When the operation of the wireless mouse is done, the transceiver 211 would be plugged in or snapped in the dock 225 of the wireless mouse 222 for storage, as shown in FIG. 3. The first charging circuit 213 then is electrically connected to the second charging circuit 223 via interconnection of the contacts 215 and 226. The second charging circuit 223 would command the first charging circuit 213 to discharge the power stored in the auxiliary charge storage device 214 through some interconnecting pins of the contacts 215 and 226, and charge the main battery 224 with the power from the auxiliary charge storage device 214. The charging action would be stopped when the auxiliary charge storage device 214 is fully discharge or when the main battery 224 is fully charged.

Practically, the capacity of main battery is about two to ten times of the capacity of auxiliary charge storage device 214, and the capacity of the main battery can support the wireless mouse operation about 20 to 30 days (assume eight hours operation per day). One time of charging from the auxiliary charge storage device to the main battery can increase the operation time about 2 to 10 days; and the transceiver is usually plugged in or snapped in the wireless mouse more than one times per day. Therefore, battery recharge or replacements are almost unnecessary unless the transceiver is not plugged in or snapped in the mouse for a long time.

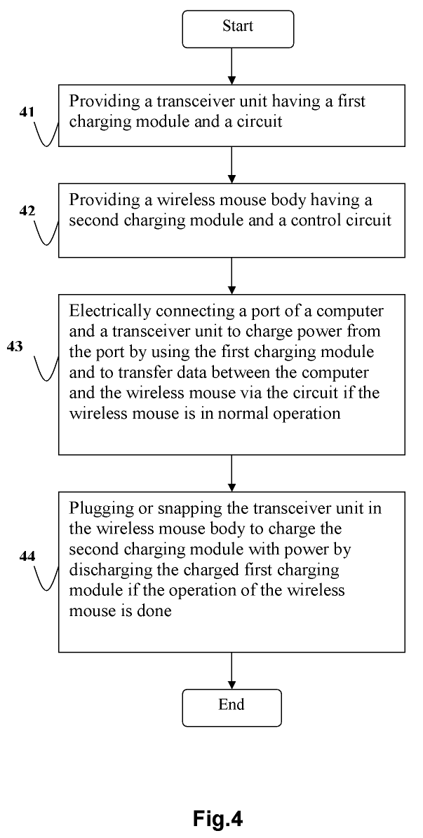

Referring to FIG. 4, a flowchart of a method for charging a wireless mouse of the invention, the method comprises the following steps:

Step 41: Providing a transceiver unit having a first charging module and a circuit;

Step 42: Providing a wireless mouse body having a second charging module and a control circuit;

Step 43: Electrically connecting a port of a computer and a transceiver unit to charge power from the port by using the first charging module and to transfer data between the computer and the wireless mouse via the circuit if the wireless mouse is in normal operation; and

Step 44: Plugging or snapping the transceiver unit in the wireless mouse body to charge the second charging module with power by discharging the charged first charging module if the operation of the wireless mouse is done.

The circuit of the transceiver unit is a transceiver circuit for performing data transmission and receiving, and the first charging module further comprises a first charging circuit and an auxiliary charge unit, and the auxiliary charge unit is an auxiliary charge storage device composed of at least one battery or a capacitor, and the first charging circuit controls the auxiliary charge unit to perform the charging and discharging action, and the second charging module further comprises a second charging circuit and a power storage unit, and the second charging circuit controls the first charging circuit to perform the charging and discharging action, and the control circuit of the wireless mouse body performs the receiving and transmission function between the wireless mouse body and the transceiver unit.

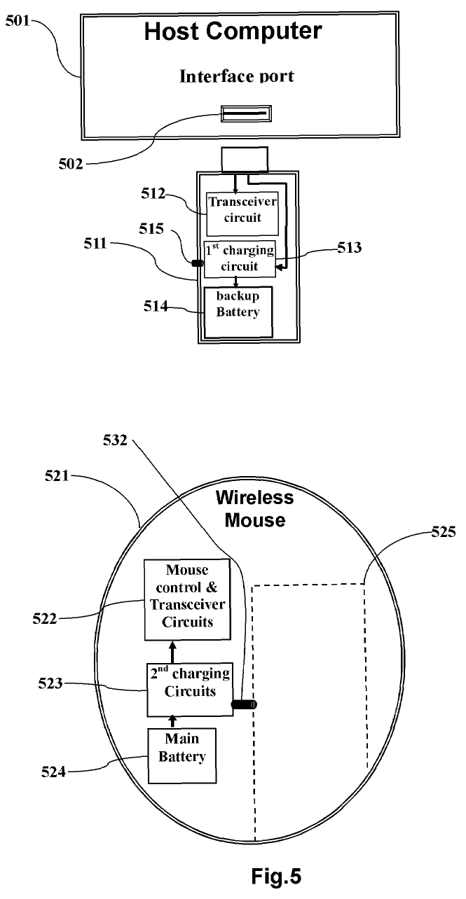

Referring to FIG. 5, a schematic diagram illustrates a charging system for a wireless mouse according to another preferred embodiment of the invention. The system 5 comprises a wireless mouse 521 and a detachable transceiver 511. The transceiver 511 is electrically connected to an interface port 502 on a host computer 501, and transfers data between the wireless mouse 521 and the host computer 501. The transceiver contains a transceiver-circuit 512, a first charging circuit 513 with contacts 515, and a backup battery 514. The transceiver circuit 512 usually receives radio signals generated from the wireless mouse 521, and converts the signals into predetermined data that then is transmitted to the host computer 501. Moreover, the transceiver circuit 512 also converts data received from the host computer 501 into radio signals, and transmits the radio signals to the wireless mouse 521. The power of the transceiver circuit 512 is supplied from the interface port 502 on the host computer 501. The first charging circuit 513 manages the charging and discharging of the backup battery 514. The contacts 515 include a plurality of metal pins for signals and power interconnection between charging circuits. The wireless mouse 521 includes a transceiver dock 525, a control-and-transceiver circuit 522, a second charging circuit 523 with contacts 526, and the main battery 524. The transceiver dock 525 is for the storage of transceiver 311. The control-and-transceiver circuit 522 converts all the user commands (mouse movement, button clicking, and scrolling-wheel rolling, etc.) into data, and transforms data into radio signals that then are transmitted to the transceiver 311. Furthermore, the control-and-transceiver circuit 522 also receives the radio signals from transceiver 511 to access data carried by the radio signals. The power of the control-and-transceiver circuit 522 is managed by the second charging circuit 523 and from the main battery 524. The second charging circuit manages the charging and discharging operation of the main battery 524. The contacts 526 include a plurality of pins for signals and power interconnection between these charging circuits. Both main and backup batteries are identical and can be exchanged between the transceiver and the wireless mouse.

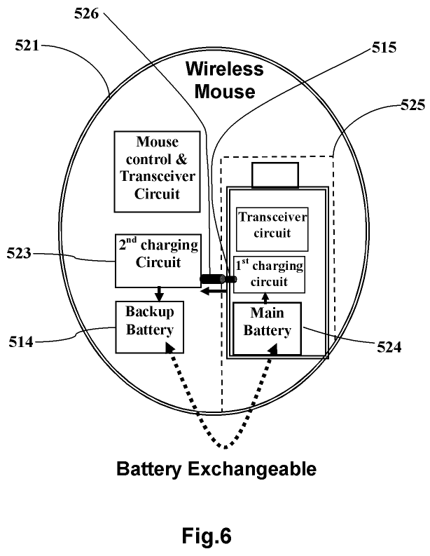

In normal mouse operation as shown in FIG. 5, the transceiver 511 is electrically connected to the interface port 502 on the host computer 501, and the user controls the wireless mouse for computer operation. The transceiver-circuit 512 and the control-and-transceiver circuit 522 transfer the user commands to the host computer 501, and data from the host computer 501 to the wireless mouse 521. When the first charging circuit 513 detects the power on the interface port 502, and it charge the backup battery 514 with the power from the interface port till the backup battery 514 is fully charged. The second charging circuit 523 manages the discharge of main battery 524, and supplies the power to the control-and-transceiver circuit 522. When the power of main battery is used up, the main battery and backup battery can be exchanged between the transceiver 511 and the wireless mouse 521 as shown in FIG. 6 so as to increase the flexibility.

Furthermore, when the operation of the wireless mouse is done, the transceiver 511 would be plugged or snapped in the wireless mouse 521 for storage. The first charging circuit 513 would be electrically connected to the second charging circuit 523 via interconnection of contacts 515 and 526. The second charging circuits 523 would command the first charging circuit 513 to discharge the power stored in the backup battery 514 through some interconnecting pins in the contacts 515 and 526, and charge the main battery 524 with the power from the backup battery 514. The charging would be stopped when the backup battery 514 is fully discharge or the main battery 524 is fully charged.

The main battery can be replaced with the backup battery when it is run out, and the main battery can also be charged with the power of the backup battery in the transceiver.

While the invention has been described by ways of examples and in terms of the preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A charging system for a wireless mouse, comprising:
a transceiver unit having a first charging module and a circuit; and
a wireless mouse body having a second charging module and a control circuit,
wherein the transceiver unit is detachable, and when the wireless mouse is in normal operation, the transceiver unit is electrically connected to a port of a computer to charge power from the port by using the first charging module and to transfer data between the computer and the wireless mouse via the circuit, and when the operation of the wireless mouse is done, the transceiver unit is plugged or snapped in the wireless mouse body to charge the second charging module with power by discharging the charged first charging module.

2. The charging system as claimed in claim 1 wherein the transceiver unit is a transceiver.

3. The charging system as claimed in claim 1 wherein the circuit is a transceiver circuit that performs the data transmission and receiving.

4. The charging system as claimed in claim 1 wherein the first charging module further comprises a first charging circuit and an auxiliary charge unit.

5. The charging system as claimed in claim 4 wherein the auxiliary charge unit is an auxiliary charge storage device composed of at least one battery or a capacitor for storing power.

6. The charging system as claimed in claim 4 wherein the first charging circuit controls the auxiliary charge unit to perform the charging and discharging action.

7. The charging system as claimed in claim 1 wherein the second charging module further comprises a second charging circuit and a power storage unit.

8. The charging system as claimed in claim 7 wherein the power storage unit is a main battery composed of at least one rechargeable battery.

9. The charging system as claimed in claim 7 wherein the second charging circuit controls the first charging circuit to perform the charging and discharging actions to charge the power storage unit.

10. The charging system as claimed in claim 1 wherein the control circuit performs the receiving and transmission function between the wireless mouse body and the transceiver unit.

11. A method for charging a wireless mouse, comprising the steps of:
providing a transceiver unit having a first charging module and a circuit;
providing a wireless mouse body having a second charging module and a control circuit;
electrically connecting a port of a computer and a transceiver unit to charge power from the port by using the first charging module and to transfer data between the computer and the wireless mouse via the circuit if the wireless mouse is in normal operation; and
plugging or snapping the transceiver unit in the wireless mouse body to charge the second charging module with power by discharging the charged first charging module if the operation of the wireless mouse is done.

12. The method for charging the wireless mouse as claimed in claim 11, further comprising the step of providing a transceiver circuit for performing the data transmission and receiving to be the circuit.

13. The method for charging the wireless mouse as claimed in claim 11, further comprising the step of providing a first charging circuit and an auxiliary charge unit to be contained in the first charging module.

14. The method for charging the wireless mouse as claimed in claim 13, further comprising the step of providing an auxiliary charge storage device composed of at least one battery or a capacitor to be the auxiliary charge unit.

15. The method for charging the wireless mouse as claimed in claim 13, further comprising the step of utilizing the first charging circuit to control the auxiliary charge unit to perform the charging and discharging actions.

16. The method for charging the wireless mouse as claimed in claim 11, further comprising the step of providing a second charging circuit and a power storage unit to be contained in the second charging module.

17. The method for charging the wireless mouse as claimed in claim 16, further comprising the step of utilizing the second charging circuit to control the first charging circuit to perform the charging and discharging actions.

18. The method for charging the wireless mouse as claimed in claim 11, further comprising the step of utilizing the control circuit to perform the receiving and transmission function between the wireless mouse body and the transceiver unit.

19. A charging system for a wireless mouse, comprising:
a transceiver unit having a circuit and a first charging module composed of a first charging circuit and a first power storage unit; and
a wireless mouse body having a second charging module composed of a second charging circuit and a second power storage unit and a control circuit,
wherein the transceiver unit is detachable, and when the wireless mouse is in normal operation, the transceiver unit is electrically connected to a port of a computer to use the first charging circuit to charge the first power storage unit of the transceiver unit with power from the port and to transfer data between the computer and the wireless mouse via the circuit, and when the power of the wireless mouse is used up, the second power storage unit of the wireless mouse body is directly replaced with the charged first power storage unit of the transceiver unit.

20. The charging system as claimed in claim 19, wherein when the operation of the wireless mouse is done, the transceiver unit is plugged or snapped in the wireless mouse body to charge the second power storage unit with power by discharging the first power storage unit, and the first power storage unit is a backup battery, and the second power storage unit is a main battery.
